(19) United States
(12) Patent Application Publication
(10) Pub. No.: US 2009/0256496 A1
(43) Pub. Date: Oct. 15, 2009

(54) Light-emitting device

(76) Inventor: Helmut Swarovski, Fritzens (AT)

Correspondence Address: WENDEROTH, LIND & PONACK, L.L.P., 1030 15th Street, N.W.,, Suite 400 East, Washington, DC, 20005-1503, US

(21) Appl. No.: 12/385,602

(22) Filed: Apr. 14, 2009

(30) Foreign Application Priority Data
Apr. 15, 2008 (AT) A592/2008

(51) Int. Cl. H05B 37/02; F21V 19/00; F21S 4/00; F21V 9/00; F21L 4/00; F21V 21/00

(52) U.S. Cl. 315/294; 362/382; 362/249.02; 362/231; 362/157; 362/392

(57) ABSTRACT

Light-emitting device (1) comprising a body which is at least substantially transparent in the visible spectral range and a light-generating device (5) which is arranged outside the body, wherein a light-emitting region is formed inside the body and wherein there is formed in the body, as a result of the arrangement of a medium having a lower index of refraction, at least in certain portions a substantially polyhedral, cylindrical or conical interface (6) which totally reflects radiation (4) which has been emitted by the light-generating device and entered the body, at least in certain portions, wherein this totally reflected radiation (4′) issues from the body so as to at least partly form the light-emitting region, wherein the interface (6) forms a cavity (3) inside the body.

The invention relates to a light-emitting device comprising a body which is at least substantially transparent in the visible spectral range and a light-generating device which is arranged outside the body, wherein a light-emitting region is formed inside the body and wherein there is formed in the body, as a result of the arrangement of a medium having a lower index of refraction, at least in certain portions a substantially polyhedral, cylindrical or conical interface which totally reflects radiation which has been emitted by the light-generating device and entered the body, at least in certain portions, wherein this totally reflected radiation issues from the body so as to at least partly form the light-emitting region.

For a relatively long time, candles have been increasingly replaced by electric light-emitting devices, on the one hand for safety reasons, as exposure to open fire always entails risks, and on the other hand for reasons of convenience. Particularly frequently, electric candles of this type are used in chandeliers or else in Christmas tree decorations. It has been found to be disadvantageous in this regard that the appearance of the electric candles and also the irradiation of light therefrom are regarded by many people as being artificial and unnatural. AT 411847 B represents an improvement in this regard, as it describes an electric light-emitting device in the form of a candle, wherein the light emitted by a light source passes into the upper light-emitting portion at least partly via a candle shaft. The fact that the light issues from the electric light-emitting device in the form of a candle mainly in the pointed region of the light-emitting portion has been found to be troublesome in this arrangement, as the geometric conditions for total internal reflection are no longer fulfilled here. An electric light-emitting device of this type is for this reason often felt to lack authenticity.

In addition to the known illumination devices such as light bulbs, light-emitting diodes or the like, a body which is embodied in a substantially solid manner but is transparent can also be used as a light-emitting device. In order to embody a shapely body of this type in such a way that light beams issue from its interior in a selected direction, it is for example known in the art to create a hollow space in a body of this type and to arrange therein a light-generating device, for example in the form of a light-emitting diode. It has been found to be disadvantageous in this regard that electric current has in this case to be fed in a complex-manner. Furthermore, in order to attain a certain brightness, use must be made of high-power light-emitting diodes which generate a lot of heat; this can generally have an adverse effect on the body and even lead to destruction thereof. Moreover, if the light-generating device is not in operation, said light-generating device and also the electric feed lines are visible inside the body; this may be felt to be unattractive.

As a further possibility for having light beams issue from the interior of a body in a predefined direction, it is known in the art to create inside the body a hollow space which is irradiated via externally arranged light-generating devices. Arranged in the hollow space are in this case optical elements, such as a lens or a prism, which cause light to be deflected in a desired direction. As a result, it is possible to imitate a light-generating device inside a body. In addition to the complex construction, internally arranged optical elements produce, in this case too, the drawback that the arrangement of the optical elements can be seen in the hollow space when the light-generating device is not in operation.

EP 1 714 593 discloses a decorative element comprising a transparent suspensible body with a large number of disordered and non-uniform air bubbles enclosed in the transparent body. Furthermore, a light source is provided, which radiates into the transparent body light which is then reflected by the air bubbles. This arrangement has the drawback that, owing to the randomly arranged air bubbles having a non-uniform shape, the light reflected by said air bubbles is diffuse and illumination of a predefined, specific angular range by the reflected light is in principle not possible.

GB 2 372 091 A1 discloses a light-emitting device with an optical element which serves to control the irradiation of light in the horizontal and vertical direction. A light-emitting diode is arranged below the optical element, wherein radiation emitted by the light-emitting diode enters, with refraction of light, the optical element, is totally reflected there and issues, if appropriate with a further refraction of light, from the transparent body, preferably in the horizontal direction. In order to protect a cone of revolution-shaped recess which serves to implement the total reflection, a dust-protective cover is arranged above the recess.

U.S. Pat. No. 6,002,079 discloses a decorative light-emitting article consisting of a transparent body and a light source arranged in a recess, wherein there are arranged at the edge of the transparent body recesses via which the light is reflected outward from the interior of the transparent body.

WO 2006/104898 A1 discloses an electric candle, the candle shaft of which consists of a fiber optic, wherein in one embodiment there is arranged at the upper end of the fiber optic an optical element which has in turn at its upper end a recess via which light can issue from the optical element by means of total internal reflection.

The object of the invention is to avoid the above-mentioned drawbacks and to deflect, in a simple manner in terms of design, light from a light-generating device, arranged outside a substantially transparent body, in the interior of the body into a specific predefined angular range and as a result to provide a light-emitting region inside a body, without even a light-generating device being arranged there. In this case, the light-emitting region is to be embodied in a shapely manner and be protected from external influences, without the irradiation characteristic of the light-emitting device being adversely influenced in the process.

This is achieved by a light-emitting device having the features of claim 1.

As a result of the light-generating device, which is arranged outside the body, a complex and unattractive supply of power into the interior of the body can be avoided, as a result of which the problems of cooling a light source which becomes very hot inside a body are no longer relevant. If the light now enters the body from a light-generating device arranged outside it, then it impinges, inside a body according to the invention, an interface to a medium having a lower index of refraction than that of the substantially transparent body. At this transition from a medium having a higher index of refraction to a medium having a lower index of refraction the angle of the light coming from the light-generating device and impinging the interface becomes greater, in a suitable geometric arrangement of the interface, at least in certain portions, than the critical angle for total internal reflection, the angle being measured from a line perpendicular to the interface. The light which is thereupon totally reflected light then impinges the outer face of the body and can—in the case of a suitable shape of the outer face—issue from the body, as a result of which the interface forms at least parts of a light-emitting region. As a result of an interface which is polyhedral, conical or cylindrical at least in certain portions, the geometric condition for total internal reflection is fulfilled not only pointwise but rather for extended regions, as the angle of the light impinging an interface according to the invention changes only slowly and continuously, as a result of which the region irradiated by the light-emitting device according to the invention is also spatially extended. Throughout the disclosure, the term “a cylindrical face” refers in this case to a curved face which is produced by parallel displacement of a straight line along a curve. Conversely, a “conical face” is produced by the movement of a straight line which passes through a fixed point and is guided along a curve. Finally, a “polyhedral face” is the surface of a polyhedron, i.e. of a body which is delimited by planes. The common background of these faces is the fact that a curvature which changes only slowly must be present at least in one direction, so that the condition for total reflection is fulfilled not only at certain points but rather in an extended area.

As a result of various shapes and sizes of interfaces of this type, the regions illuminated by these interfaces can be varied. Complex lenses or prisms inside the body are no longer necessary. When the light-generating device is not in operation, then no optical elements or light sources having a troublesome effect may be seen inside the body.

The fact that provision is now made for the interface to form a cavity inside the body and as a result for the transparent body to completely enclose the light-emitting region according to the invention ensures that no external influences can influence the light-emitting region. For example, dust or similar forms of dirt cannot deposit on the light-emitting region, i.e. on the interface. In addition to the forms of dirt which are undesirable for a decorative article, a dirt layer of this type can also change the geometric conditions for total internal reflection in such a way that they can no longer be fulfilled and the light-emitting device can no longer function properly. In addition, as a result of the complete enclosure of the interfaces and thus of the light-emitting region by the transparent body, the light-emitting region is accommodated in a particularly shapely manner inside the transparent body. A dust-protective cover or similar devices which disturb the haptic impression are no longer necessary.

A further advantage resulting from the complete enclosure of the interfaces by the transparent body is the fact that light beams which laterally pass the interfaces without being totally reflected there can, once they are reflected or totally reflected on the wall, lying above the cavity, of the transparent body, be cast back to the interface and then be totally reflected at the interface to the cavity and issue from the transparent body. This increases the intensity of the light issuing from the light-emitting region, and also the intensity of the radiation deflected in a specific predefined angular range. That is to say, without the complete enclosure of the cavity, the beams passing the cavity would not be deflected or would be absorbed on a protective element such as a covering hood.

A particularly advantageous embodiment is obtained in that the substantially transparent body is a glass body. Glass is in this case distinguished as being advantageous to manufacture and extremely diverse in its possible applications and configurations. Depending on the type of glass used, the characteristic of the light issuing from the light-emitting device also changes, as the indexes of refraction for glasses lie in the range of from 1.4 to 1.9. While quartz glass has an index of refraction of 1.46, the index of refraction of flint glass lies between 1.61 and 1.76. In this case, the indexes of refraction specified in this disclosure apply to the yellow sodium line having a wavelength of 589.3 nm at 20° C. for solid substances and liquids and at 0° C. for gaseous substances. Obviously, the transparent material used can also be a suitable plastics material or precious stone. Diamond would even be extremely advantageous, as it has a particularly high index of refraction of 2.41, although its manufacturing costs would of course be much higher than those of glass.

In one embodiment, provision may be made to grind the body in a faceted manner, as a result of which the body appears particularly shapely and attractive. This applies in particular to glass bodies which are ground in a faceted manner and are generally acknowledged as being a shapely replacement for precious stones.

A further embodiment provides for the body consisting of transparent material to consist at least partly of colored material, as a result of which just as diverse appearances of the light emitted by the body consisting of transparent material are possible.

In a preferred embodiment of the invention, provision is made for the light-emitting region to be arranged centrally inside the body. As a result, depending on the configuration of the interface, particularly symmetrical irradiation of light can be ensured. In addition, a body, in particular having a surface ground in a faceted manner, which completely encloses a light-emitting region according to the invention is felt to be a very high-quality crystalline body, as, after all, when the light-generating device is not in operation, no troublesome elements may be seen inside the body.

It is in this case particularly advantageous if the cavity according to the invention is empty and is additionally or alternatively filled with a gaseous substance. As vacuum has an index of refraction of 1 and air an index of refraction of 1.0003, the ratio of the indexes of refraction of a medium which is rather impervious to light to a medium which is rather pervious to light is sufficiently large to allow total internal reflection in an adequate angular range for the light impinging the interface. However, provision may also be made to alter this ratio using other gaseous substances or else to introduce colored substances having a lower index of refraction than that of the body, which at least partly surrounds the cavity, into the cavity. Thus, the cavity can for example also be filled with liquid substances such as water, as the index of refraction for water is 1.33 and thus lower than that of glass.

In a preferred embodiment, the interface is embodied symmetrically with respect to a notional axis of the body. This allows a symmetrical light-emitting region and thus symmetrical illumination all the way round the body. This applies in particular if the body is also symmetrical and the interface has the same axis of symmetry as the body.

A further particularly advantageous embodiment of the invention provides for the interface to be embodied in a substantially smooth manner. In this case, the term “smooth” means that adjacent beams arriving in parallel are again approximately parallel after the total internal reflection and also that the geometric conditions for total reflection are fulfilled not only at certain points, but rather in an extended region of the interface. This ensures that the light originating from the light-emitting region does not have a diffuse appearance'but rather leaves behind a brilliant impression and thus has a particularly shapely and decorative appearance. A rough interface, on the other hand, causes the light originating from the light source to be totally reflected in a broad range of directions and therefore to issue from the body in a diffuse manner. In a preferred embodiment of the invention, provision is made to assemble the body from a plurality of parts. As a result, the light-emitting region which is located inside the body, together with the interface to the region having a lower index of refraction, can be manufactured in a simple manner. In at least two of the plurality of parts, parts of the interfaces are formed which then form the overall interface according to the invention when the body is assembled. Mutually corresponding recesses are provided in at least two outer faces. The corresponding outer faces are then assembled, wherein mutually corresponding recesses form a cavity inside the body. Provision may be made to fasten the parts of the body to one another, for example by adhesive bonding.

In a further embodiment, provision may be made for the interface which encloses the cavity to have the shape of a double cone. If the light source is arranged below the tips of the double cone, then light beams can be totally reflected on the outer face, lying closer to the light-generating device, of the double cone, so that the light issues from the interior of the body for the most part in a direction substantially perpendicular to the axis of symmetry of the double cone. A double cone has the additional advantage that light which is reflected by a side of the body that is remote from the light-generating device, and from there impinges the side of the double cone that is remote from the light-generating device, there again also meets the conditions for total internal reflection. This has the consequence that the irradiated light issues from the body in a particularly symmetrical and shapely manner.

In a preferred embodiment of the invention, provision is made for the light source to rest directly against the body. As a result, the light from the light source can optimally enter the body, and a particularly large proportion of the light emitted by the light-generating device can be deflected by the light-emitting device according to the invention.

It is particularly advantageous if the light source comprises at least one light-emitting diode (LED). Light-emitting diodes are distinguished on the one hand by high light emission while consuming very little power; on the other hand, light-emitting diodes are particularly small light sources and therefore allow a compact design of a light-emitting device according to the invention.

Provision may also be made for the light source to comprise a plurality of light-emitting diodes which can emit light of various colors. As a result of the fact that the critical angle for total internal reflection depends on the wavelength of the light, light of differing color, i.e. of differing wavelength, issues in various directions from the body, thus producing extremely attractive dispersive effects. In addition, a controlling device can be provided, which controls the color and the brightness of the light emitted by the light-emitting diodes, as a result of which, again, a broad range of optical impressions can be produced. Furthermore, provision may be made for the power supply to activate the light sources in such a way that said light source gives off flickering light. This produces the optical impression of natural flickering, like a flame of a wax candle; this in turn improves the imitation of such a flame by a light-emitting device according to the invention.

In a further embodiment of the invention, provision is made for the substantially transparent body to consist at least partly of colored material, thus providing again attractive optical and decorative possible configurations.

In a further embodiment of the invention, provision is made for the light-emitting device to be tapered at the top, that is to say, on the side further removed from the light-generating device, conically to form a tip. This allows a natural flame to be imitated particularly effectively, because at the conically tapering tip the geometric conditions for total reflection are no longer fulfilled and the light emitted by the light-generating device also issues in intensified form at the conically tapered tip, as well as from the light-emitting region according to the invention. In addition, light reflected at the conically tapering tip is cast back onto the interface to the cavity and issues there laterally from the transparent body, forming the light-emitting region, once it has been totally reflected at the interface.

In a further advantageous variant of the invention, provision is made for a candle shaft to be arranged on the light-emitting device and for the light-emitting device to form a light-emitting portion, lying above the candle shaft, of an electric light-emitting device in the form of a candle, similar to an arrangement such as is presented in AT 411 847 B. In this case, the light-emitting device can form a light-emitting portion stylizing a flame, wherein as a result of the arrangement of the light-emitting region in the body of the light-emitting device and the resulting lateral issuing of the light, a candle having a natural flame can be imitated particularly effectively. In this case, provision may be made for the light-generating device to be arranged in the lower region of, preferably exclusively below, the candle shaft and in addition for it to rest against the candle shaft, as a result of which the light emitted by the light-generating device enters the candle shaft in a particularly advantageous manner and passes into the upper light-emitting portion at least partly via said candle shaft. This allows the light-generating device to be arranged so as to be outwardly not visible, as a result of which the light-emitting device forming the light-emitting portion is indirectly illuminated and the light-emitting region which is located in this light-emitting device can be shown to particular advantage. As, depending on the geometric shape and arrangement of the interface, in a light-emitting device according to the invention, the light of the light-emitting region issues from the light-emitting device in a specific direction, extremely attractive optical effects can be attained.

Provision may also be made for light to be supplied to the light-emitting portion exclusively through the candle shaft. The light entering the candle shaft from below is guided, for example by way of total internal reflection, into the upper light-emitting portion, where it finally issues from the light-emitting device at least partly via the light-emitting region according to the invention. This limits the issuing of light to the light-emitting portion and, in this case too, in particular to the light-emitting region, producing an optically extremely attractive effect. Of course, the candle shaft could also be at least partly covered with a mirroring layer.

A further possibility would be to arrange a light-generating device in a hole located on the candle shaft, wherein the light-generating device can be supplied with power for example through conductor tracks which are vapor-deposited onto the candle shaft.

A further advantageous embodiment of the invention makes provision for the above-mentioned candle shaft to be made of a material which is substantially transparent in the visible spectral range. In particular, provision may be made for this material to be glass. In order to obtain a particularly shapely light-emitting device according to the invention in the form of a candle, provision may furthermore be made for the candle shaft to be ground in a faceted manner.

In this case, provision may be made for the light-emitting device, which forms the light-emitting portion, and the candle shaft to be formed in one piece, thus producing particularly diverse possible designs. However, provision may also be made for the candle shaft to be manufactured separately from the light-emitting device, which forms the light-emitting portion, and for the light-emitting portion to be fastened, for example by adhesive bonding, as a separate part to the candle shaft.

In order to be able to operate the light-emitting device according to the invention as independently as possible from the electricity network and to place it at any desired locations, provision may in one embodiment of the invention be made for power to be supplied via batteries or accumulators. For example, batteries or accumulators of this type can be arranged below a candle shaft. Of course, it is also possible to supply power externally via conductors.

Further details and advantages of the present invention will be commented on hereinafter in greater detail based on the description of the figures with reference to the drawings, in which:

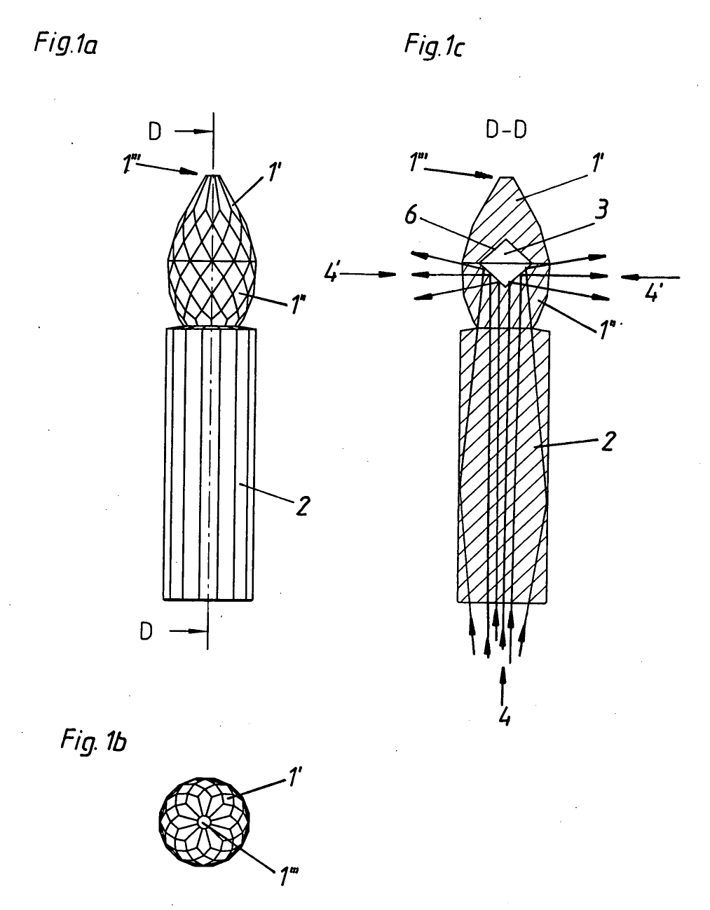

FIG. 1a to 1b are a side view, a plan view and also a sectional view taken along the axis D-D from FIG. 1a of a light-emitting device according to the invention on which a candle shaft is arranged; and

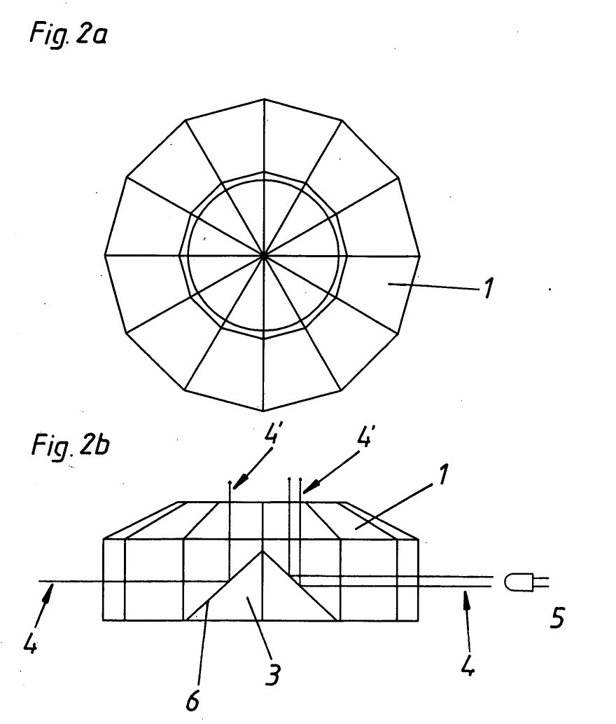

FIGS. 2a and 2b are a cross section and also a plan view of a light-emitting device according to the prior art.

FIG. 1a shows a light-emitting device 1 which comprises two parts 1′, 1″ which are joined together, for example by adhesive bonding. The two parts 1′, 1″ are in this case each glass bodies ground in a faceted manner. Also arranged on the light-emitting device 1 below the light-emitting device 1 is a candle shaft 2 which is also made from glass ground in a faceted manner. The candle shaft 2 is in this case fastened to the light-emitting device 1, for example also by adhesive bonding. FIG. 1b is a plan view of the foregoing light-emitting device 1 according to the invention. The sectional view shown in FIG. 1c, taken along the axis D-D from FIG. 1a, shows the interface 6 which in this embodiment of the invention is embodied as a lateral face of a double cone, as a result of the arrangement of a cavity 3 which is empty or for example filled exclusively with air. In this exemplary embodiment, the cavity 3, and thus the light-emitting region, is arranged centrally inside the light-emitting device 1. The light beams 4, which are emitted by a light-generating device 5 (not shown here) arranged below the cone shaft 2, enter, as may be seen from the illustrated paths of the beams, the candle shaft 2 at the bottom and are guided into the light-emitting device 1 as a result of total internal reflection on the lateral face of the candle shaft 2. The light-emitting device 1 forms a light-emitting portion stylizing a flame and thus produces, together with the candle shaft 2, a candle-shaped electric light-emitting candle. At the interface 6 to the medium with the lower index of refraction in the cavity 3, the conditions for total internal reflection are fulfilled at least in certain portions, whereupon the totally reflected beams 4′ issue laterally from the light-emitting device. Light beams 4, which are guided further upward as a result of total reflection on the outer face of the light-emitting device 1, issue partly at the tip 1′″, which is in this exemplary embodiment conically tapered, of the light-emitting device 1, as the geometric conditions for total reflection are no longer fulfilled here. However, in addition to the radiation issuing here, radiation is also reflected downward here and impinges the upper part of the interface 6 and is, here too, totally reflected at least in certain portions (not represented here by beam paths) and issues from the light-emitting device 1. As a result, the intensity of the beams 4′, which are totally reflected by the interface 6 of the cavity 3 and form a light-emitting region, is increased and, in addition, the interface 6 is protected by the material, lying above the cavity 3, of the transparent body from external influences and a layer of dust cannot deposit on the interface 6, as a result of which the total internal reflection could be adversely influenced and, for example, the geometric conditions for this total internal reflection could no longer be fulfilled.

FIG. 2a is a plan view of a light-emitting device 1 made from glass ground in a faceted manner according to the prior art. The cross-sectional view shown in FIG. 2b shows the interface 6 which is embodied as a result of the arrangement of a conical recess. Light beams 4 emitted by a light-generating device 5 enter the light-emitting device 1 and are totally reflected, at least in certain portions, at the interface 6, as a medium having a lower index of refraction is arranged in the recess. A plurality of light-generating devices can also be provided, for example on opposing sides of the light-emitting device 1. The light beams 4′, which are deflected as a result of the total internal reflection, issue at the upper side of the light-emitting device 1 and form in this case at least partly a light-emitting region inside the light-emitting device 1, as a result of which a light source is imitated inside the light-emitting device. As a result of the fact that the transparent body does not completely enclose the recess and as a result no cavity is formed, the interface 6 is not protected from external influences and it is very easy for a layer of dust or other forms of dirt to deposit on this interface 6; this would disturb the conditions for the total internal reflection. In addition, light which does not enter the body from the light-generating device 5 can laterally pass the recess and issues simply at the underside of the body, without the possibility of it being reflected back onto the interface 6 and as a result being able to enlarge the intensity of the radiation 4′ irradiated from the light-emitting region.

For the sake of clarity, none of the figures show the batteries supplying the light sources or, in the case of an external power supply, the cables.

The present invention is not limited to the exemplary embodiments shown but rather includes or extends to all variants and technical equivalents which may come under the scope of the subsequent claims.

Also, the positional particulars selected in the description, such as for example “top”, “bottom”, “laterally”, etc. are based on the immediately described and also illustrated figure and are analogously transferable, in the event of a change of position, to the new position.

1. A light-emitting device comprising a body which is at least substantially transparent in the visible spectral range and a light-generating device which is arranged outside the body, wherein a light-emitting region is formed inside the body and wherein there is formed in the body, as a result of the arrangement of a medium having a lower index of refraction, at least in certain portions a substantially polyhedral, cylindrical or conical interface which totally reflects radiation which has been emitted by the light-generating device and entered the body, at least in certain portions, wherein this totally reflected radiation issues from the body so as to at least partly form the light-emitting region, wherein the interface forms a cavity inside the body.

2. The light-emitting device as claimed in claim 1, wherein the body is a glass body.

3. The light-emitting device as claimed in claim 2, wherein the body is ground in a faceted manner.

4. The light-emitting device as claimed in claim 1, wherein the light-emitting region is arranged centrally inside the body.

5. The light-emitting device as claimed in claim 1, wherein the cavity is at least one selected from the group being empty and filled with a gaseous substance.

6. The light-emitting device as claimed in claim 1, wherein the interface is embodied substantially symmetrically with respect to a notional axis through the body.

7. The light-emitting device as claimed in claim 1, wherein the interface is substantially smooth.

8. The light-emitting device as claimed in claim 1, wherein the body comprises a plurality of parts, wherein the interface is formed by faces of at least two of the plurality of parts.

9. The light-emitting device as claimed in claim 8, wherein the cavity has the shape of a double cone or a double-sided pyramid.

10. The light-emitting device as claimed in claim 1, wherein the light-generating device rests against the body.

11. The light-emitting device as claimed in claim 1, wherein the light-generating device comprises at least one light-emitting diode (LED).

12. The light-emitting device as claimed in claim 1, wherein the light-generating device comprises a plurality of light-emitting diodes (LEDs) which can emit radiation of various colors.

13. The light-emitting device as claimed in claim 1, wherein a controlling device is provided, which controls the brightness and the color of the radiation emitted by the light-generating device

14. The light-emitting device as claimed in claim 1, wherein the body consists at least partly of colored material.

15. The light-emitting device as claimed in claim 1, wherein the body is tapered at the top conically to form a tip.

16. The light-emitting device as claimed in claim 9, wherein the body is tapered at the top conically to form a tip.

17. The light-emitting device as claimed in claim 1, wherein a power supply is provided, which activates the light-generating device in such a way that said light-generating device emitts flickering radiation.

18. The light-emitting device as claimed in claim 1, wherein power is supplied to the light-generating device via batteries or accumulators.

19. The light-emitting device as claimed in claim 1, wherein a candle shaft is arranged on the light-emitting device, wherein the light-emitting device forms a light-emitting portion stylizing a flame and the light-generating device is arranged in the lower region, which is remote from the light-emitting device of the candle shaft and preferably rests thereagainst, wherein the radiation emitted by the light-generating device passes into the upper light-emitting device at least partly via the candle shaft.

20. The light-emitting device as claimed in claim 19, wherein the light-generating device is arranged exclusively below the candle shaft.

21. The light-emitting device as claimed in claim 19, wherein light is supplied to the light-emitting device exclusively through the candle shaft.

22. The light-emitting device as claimed in claim 19, wherein the candle shaft consists of transparent material.

23. The light-emitting device as claimed in claim 22, wherein the candle shaft consists of glass.

24. The light-emitting device as claimed in claim 23, wherein the candle shaft is ground in a faceted manner.

25. The light-emitting device as claimed in claim 19, wherein the candle shaft and the light-emitting device are formed in one piece.

26. The light-emitting device as claimed in claim 19, wherein said light-emitting device, which is embodied as a separate part in the form of a flame, is fastened to the candle shaft.

27. The light-emitting device as claimed in claim 26, wherein the light-emitting device is adhesively bonded to the candle shaft.

28. The light-emitting device as claimed in claim 19, wherein power is supplied to the light-generating device via batteries or accumulators.

29. The light-emitting device as claimed in claim 28, wherein said batteries or accumulators are arranged in the lower region of or below the candle shaft.
